(19) United States
(12) Patent Application Publication
(10) Pub. No.: US 2023/0171698 A1
(43) Pub. Date: Jun. 1, 2023

(54) BROADCAST OR MULTICAST WAKEUP SIGNALS AND DISCONTINUOUS RECEPTION

(71) Applicant: QUALCOMM Incorporated, San Diego, CA (US)

(72) Inventors: Chao WEI, Beijing (CN); Min HUANG, Beijing (CN); Hao XU, Beijing (CN); Jing DAI, Beijing (CN); Qiaoyu LI, Beijing (CN)

(21) Appl. No.: 17/996,908

(22) PCT Filed: Jun. 26, 2020
(86) PCT No.: PCT/CN2020/098309

§ 371 Date: Oct. 21, 2022

(51) Int. Cl. H04W 52/02; H04W 72/23

(52) U.S. Cl. CPC H04W 52/0232; H04W 72/23

(57) ABSTRACT

Various aspects of the present disclosure generally relate to wireless communication. In some aspects, a user equipment may receive, from a base station, downlink control information that indicates a wakeup signal for a broadcast or multicast (broadcast/multicast) session in a session-specific field of the downlink control information. The user equipment may selectively perform, for the broadcast/multicast session, a wakeup operation for a discontinuous reception cycle based at least in part on the wakeup signal. Numerous other aspects are provided.

### FIELD OF THE DISCLOSURE

Aspects of the present disclosure generally relate to wireless communication and to techniques and apparatuses for broadcast or multicast wakeup signals and discontinuous reception.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment for wireless communication includes: a memory; and one or more processors coupled to the memory, the memory and the one or more processors configured to: receive, from a base station, downlink control information that indicates a wakeup signal for a broadcast or multicast (broadcast/multicast) session in a session-specific field of the downlink control information; and selectively perform, for the broadcast/multicast session, a wakeup operation for a discontinuous reception cycle based at least in part on the wakeup signal.

In some aspects, a base station for wireless communication includes: a memory; and one or more processors coupled to the memory, the memory and the one or more processors configured to: determine, for a broadcast/multicast session, whether a user equipment is to perform a wakeup operation for a discontinuous reception cycle; and transmit, to the user equipment, downlink control information that indicates a wakeup signal for the broadcast/multicast session in a session-specific field of the downlink control information.

In some aspects, a non-transitory computer-readable medium storing a set of instructions for wireless communication includes: one or more instructions that, when executed by one or more processors of a user equipment, cause the user equipment to: receive, from a base station, downlink control information that indicates a wakeup signal for a broadcast/multicast session in a session-specific field of the downlink control information; and selectively perform, for the broadcast/multicast session, a wakeup operation for a discontinuous reception cycle based at least in part on the wakeup signal.

In some aspects, a non-transitory computer-readable medium storing a set of instructions for wireless communication includes: one or more instructions that, when executed by one or more processors of a base station, cause the base station to: determine, for a broadcast/multicast session, whether a user equipment is to perform a wakeup operation for a discontinuous reception cycle; and transmit, to the user equipment, downlink control information that indicates a wakeup signal for the broadcast/multicast session in a session-specific field of the downlink control information.

In some aspects, a method of wireless communication performed by a user equipment includes: receiving, from a base station, downlink control information that indicates a wakeup signal for a broadcast/multicast session in a session-specific field of the downlink control information; and selectively performing, for the broadcast/multicast session, a wakeup operation for a discontinuous reception cycle based at least in part on the wakeup signal.

In some aspects, a method of wireless communication performed by a base station includes: determining, for a broadcast/multicast session, whether a user equipment is to perform a wakeup operation for a discontinuous reception cycle; and transmitting, to the user equipment, downlink control information that indicates a wakeup signal for the broadcast/multicast session in a session-specific field of the downlink control information.

In some aspects, an apparatus for wireless communication includes: means for receiving, from a base station, downlink control information that indicates a wakeup signal for a broadcast/multicast session in a session-specific field of the downlink control information; and means for selectively performing, for the broadcast/multicast session, a wakeup operation for a discontinuous reception cycle based at least in part on the wakeup signal.

In some aspects, an apparatus for wireless communication includes: means for determining, for a broadcast/multicast session, whether a user equipment is to perform a wakeup operation for a discontinuous reception cycle; and means for transmitting, to the user equipment, downlink control information that indicates a wakeup signal for the broadcast/multicast session in a session-specific field of the downlink control information.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of single cell point to multipoint (SC-PTM) communication, in accordance with various aspects of the present disclosure.

FIG. 4 is a diagram illustrating an example of a discontinuous reception (DRX) configuration, in accordance with various aspects of the present disclosure.

FIGS. 5A-5E are diagrams illustrating examples associated with broadcast or multicast wakeup signals and discontinuous reception, in accordance with various aspects of the present disclosure.

FIGS. 6 and 7 are diagrams illustrating example processes associated with broadcast or multicast wakeup signals and discontinuous reception, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

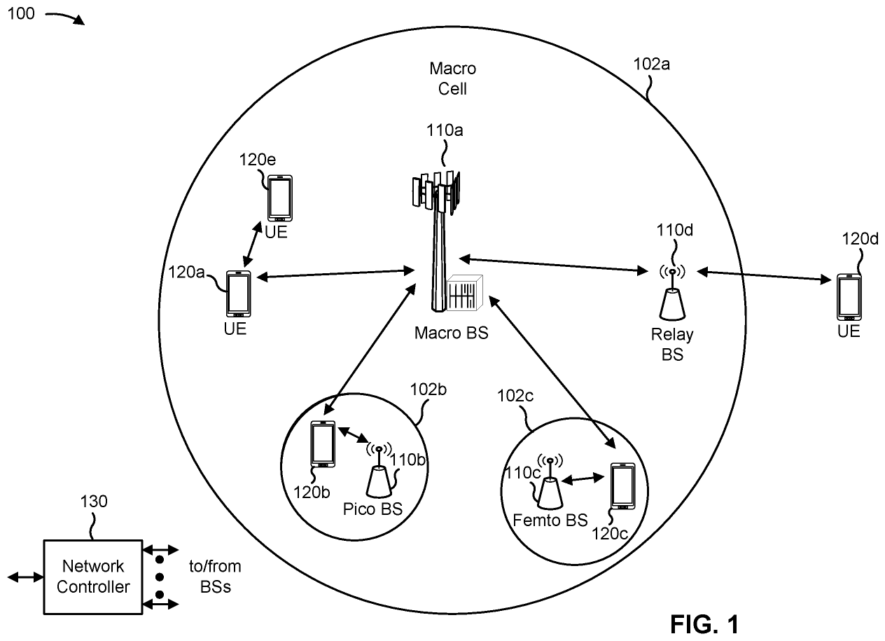

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

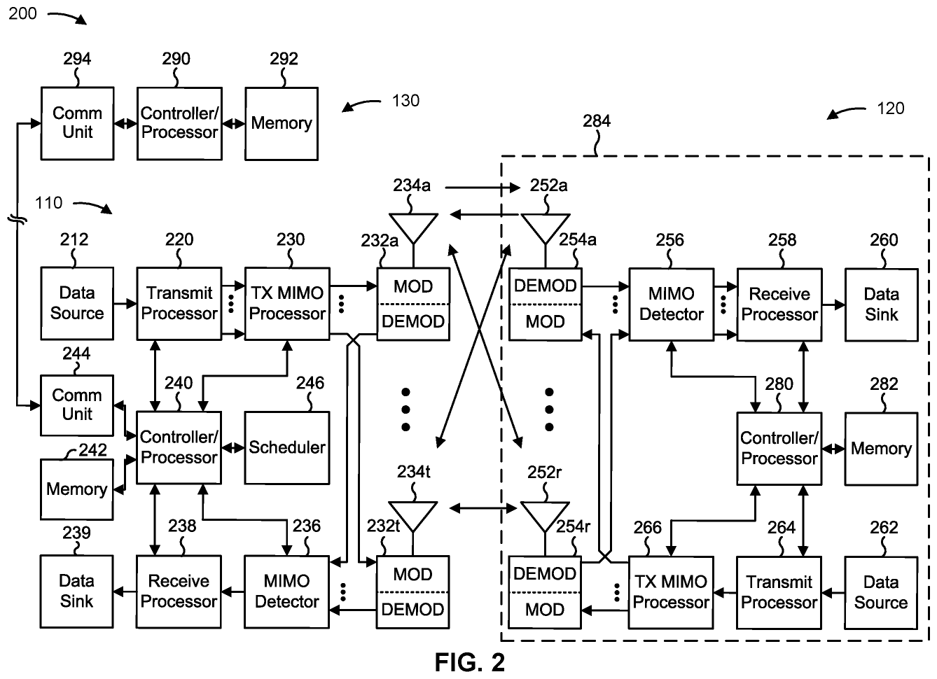

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T>1 and R>1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

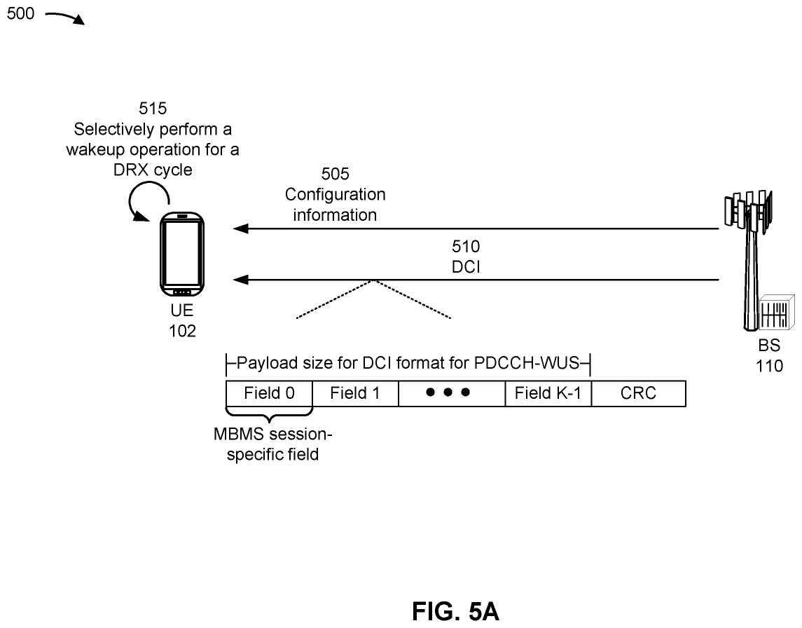

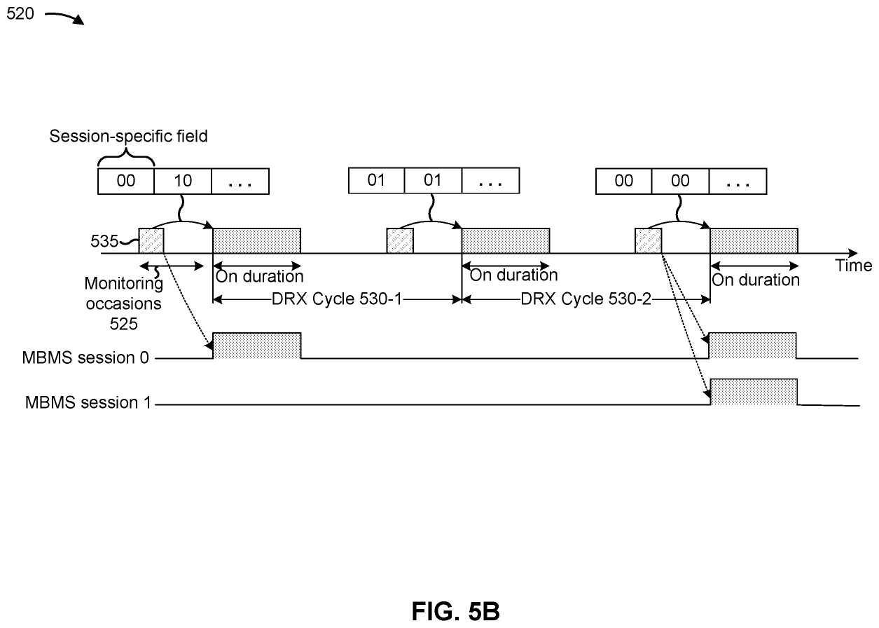

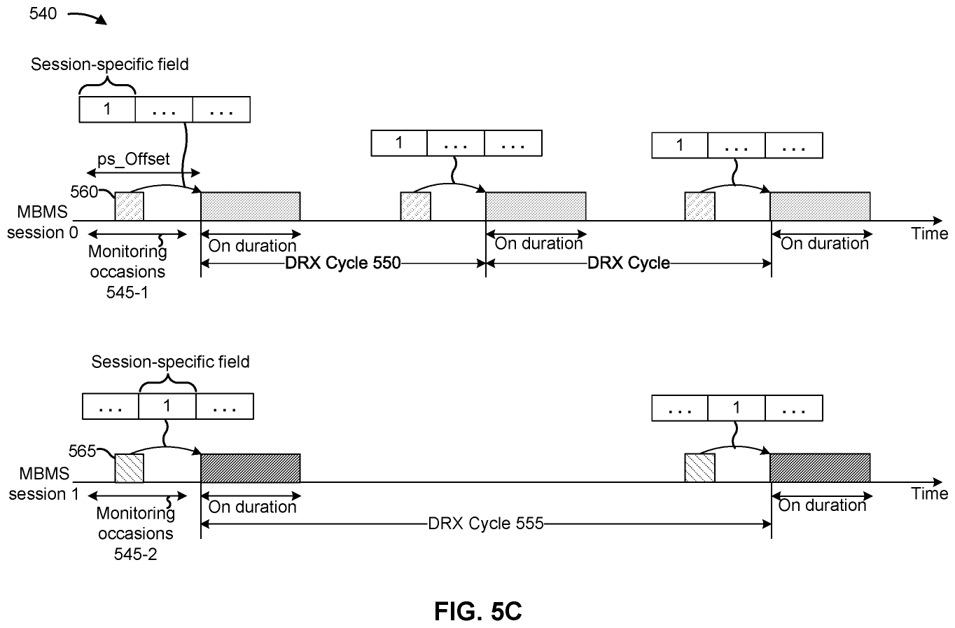

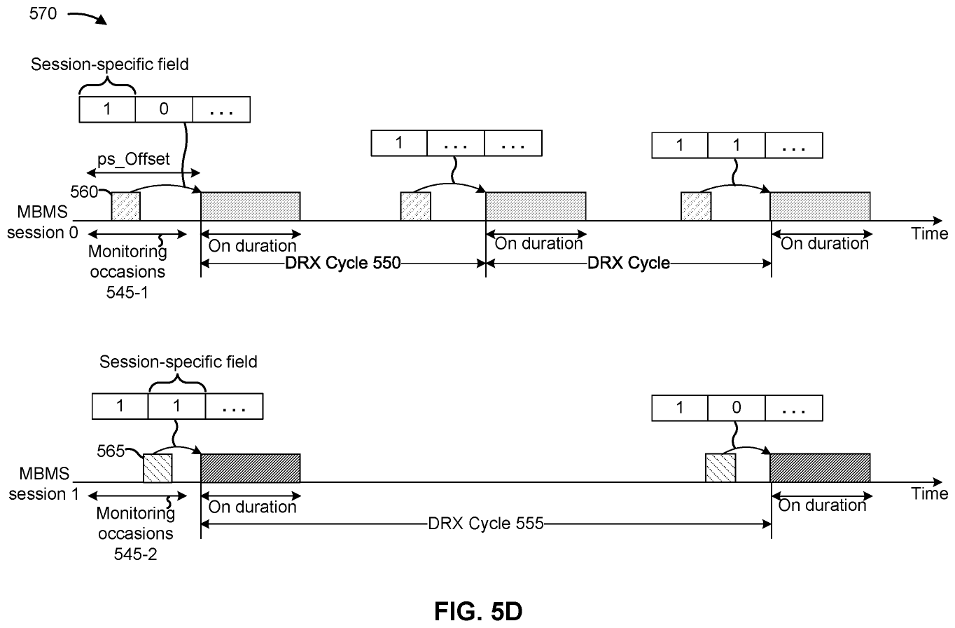

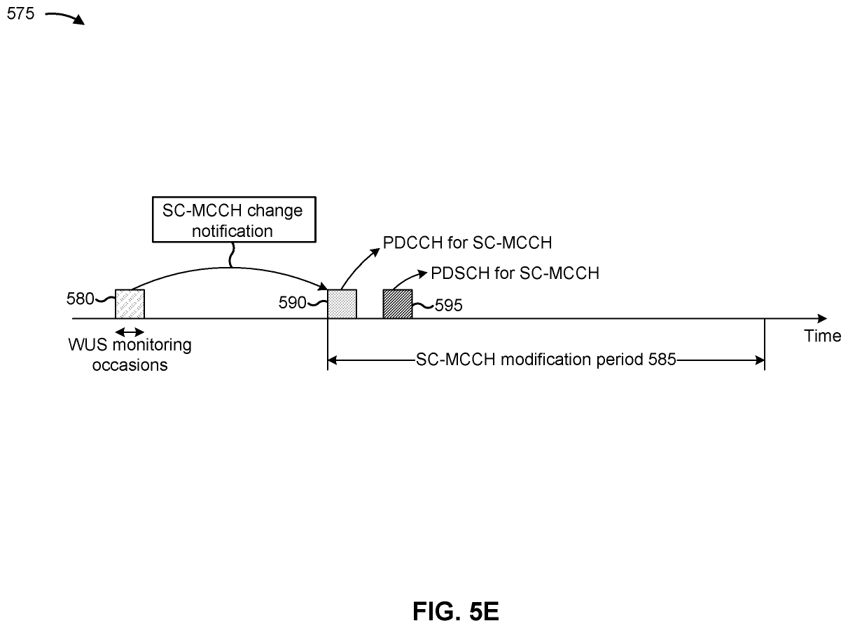

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 5A-5E, 6, and 7.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 5A-5E, 6, and 7.

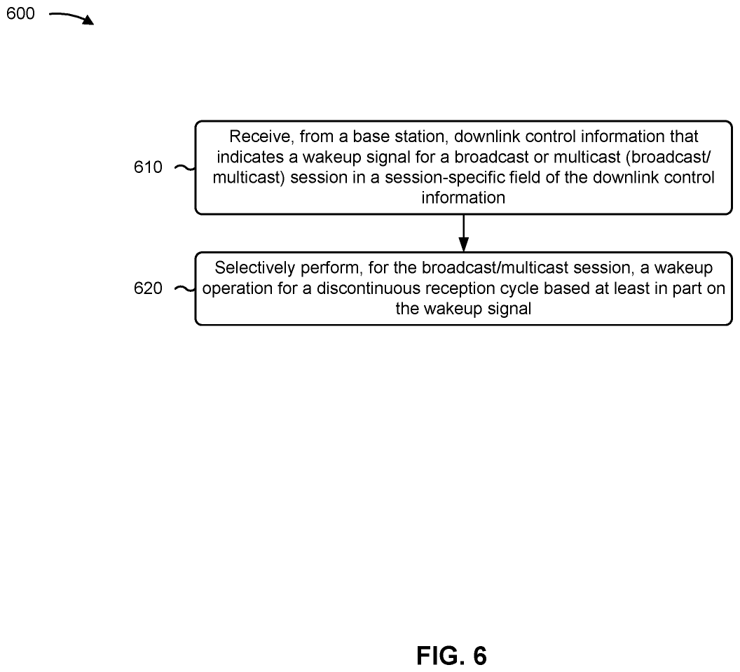

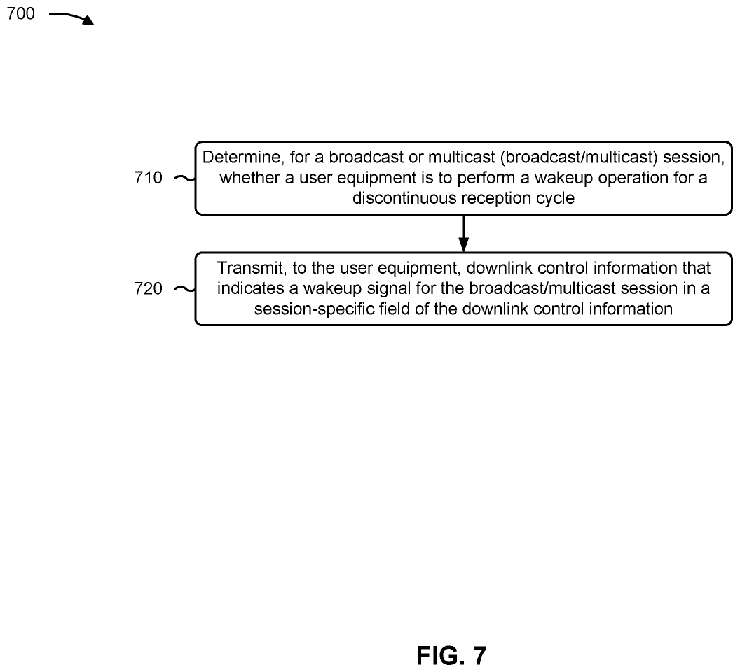

Controller/processor 240 of base station 110, controller/processor 280 of UE 120, and/or any other component(s) of FIG. 2 may perform one or more techniques associated with broadcast or multicast wakeup signals and discontinuous reception (DRX), as described in more detail elsewhere herein. For example, controller/processor 240 of base station 110, controller/processor 280 of UE 120, and/or any other component(s) of FIG. 2 may perform or direct operations of, for example, process 600 of FIG. 6, process 700 of FIG. 7, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some aspects, executing instructions may include running the instructions, converting the instructions, compiling the instructions, interpreting the instructions, and/or the like.

In some aspects, UE 120 may include means for receiving, from a base station, downlink control information that indicates a wakeup signal for a broadcast/multicast session in a session-specific field of the downlink control information, means for selectively performing, for the broadcast/multicast session, a wakeup operation for a discontinuous reception cycle based at least in part on the wakeup signal, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for determining, for a broadcast/multicast session, whether a user equipment is to perform a wakeup operation for a discontinuous reception cycle, means for transmitting, to the user equipment, downlink control information that indicates a wakeup signal for the broadcast/multicast session in a session-specific field of the downlink control information, and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

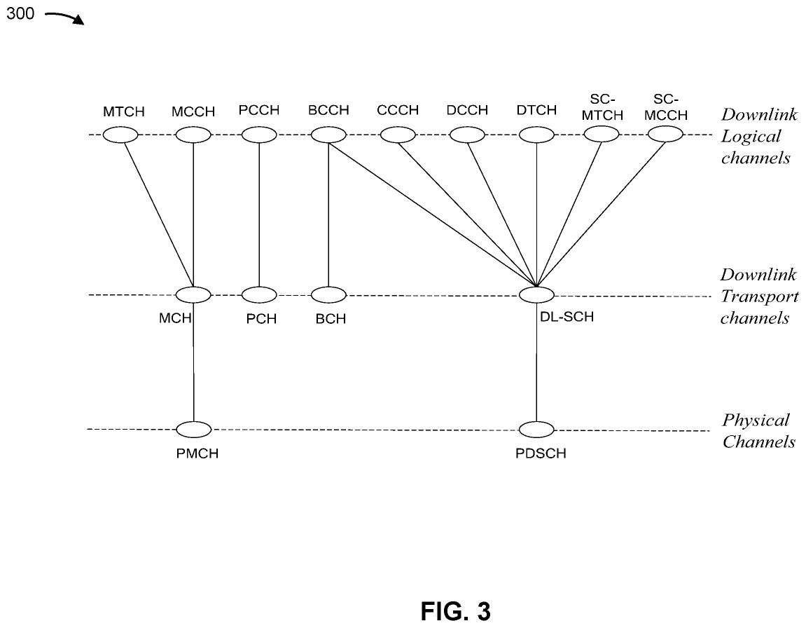

FIG. 3 is a diagram illustrating an example 300 of SC-PTM communication, in accordance with various aspects of the present disclosure. SC-PTM may be used to support multimedia broadcast or multicast (broadcast/multicast) service (MBMS) in a single cell (SC) (or a small area served by one or more cells). As shown in FIG. 3, an SC multicast traffic channel (SC-MTCH) may be mapped to a downlink shared channel (DL-SCH). The SC-MTCH may be used to carry MBMS information that is to be transmitted using SC-PTM communication. The SC-MTCH may be scheduled (e.g., dynamically) using a group radio network temporary identifier (G-RNTI). In SC-PTM, control information, such as respective G-RNTIs used for different MBMSs, is provided on an SC multicast control channel (SC-MCCH). The SC-MCCH may be scheduled (e.g., dynamically) using an SC-RNTI. Accordingly, a UE may monitor a physical downlink control channel (PDCCH) scrambled by an SC-RNTI on SC-MCCH subframes to obtain SC-MCCH scheduling, and may monitor a PDCCH scrambled by a G-RNTI on SC-MTCH subframes to obtain SC-MTCH scheduling.

In addition, a system information block (SIB) may include information that is used (e.g., by a UE) to receive the SC-MCCH. For example, the information may identify an offset for the SC-MCCH (e.g., sc-mcch-Offset-r13), a repetition period for the SC-MCCH (e.g., sc-mcch-RepetionPeriod-r13), a first subframe for the SC-MCCH (e.g., sc-mcch-FirstSubframe-r13), a duration for the SC-MCCH (e.g., sc-mcch-duration-r13), a modification period for the SC-MCCH (e.g., sc-mcch-ModificationPeriod-r13), and/or the like.

SC-MCCH information (e.g., SC-PTM configuration information) may be transmitted periodically in the modification period using a configurable repetition period. For example, downlink control information (DCI), using an SC-RNTI, may indicate a change to SC-MCCH information in the modification period. Upon receiving a change notification, a UE may acquire new SC-MCCH information in resources scheduled by the DCI.

SC-PTM configuration information carried in the SC-MCCH may identify one or more MBMS sessions that are to be transmitted in an SC-MTCH. The SC-PTM configuration information may also identify scheduling information for the one or more MBMS sessions. Moreover, an SC-PTM configuration may identify a G-RNTI, a scheduling period, a start offset, DRX information, and/or the like, for an MBMS session. An MBMS session may be associated with an MBMS (e.g., radio broadcast, video streaming, emergency alerts, and/or the like). Accordingly, different MBMS sessions may be received by different UEs or groups of UEs, and a UE may receive one or more MBMS sessions.

As indicated above, FIG. 3 is provided as an example. Other examples may differ from what is described with respect to FIG. 3.

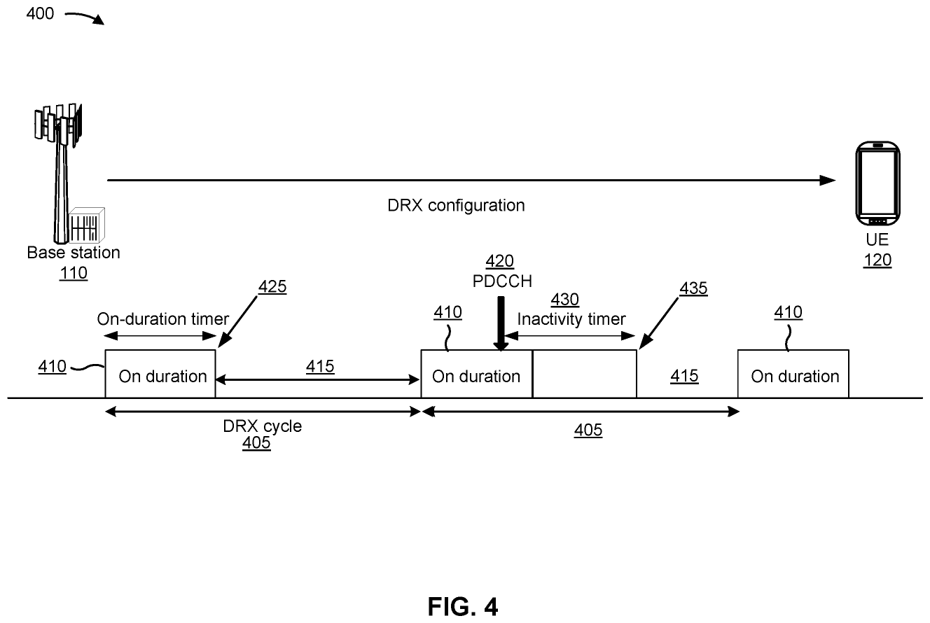

FIG. 4 is a diagram illustrating an example 400 of a DRX configuration, in accordance with various aspects of the present disclosure.

As shown in FIG. 4, a base station 110 may transmit a DRX configuration to a UE 120 to configure a DRX cycle 405 for the UE 120. A DRX cycle 405 may include a DRX on duration 410 (e.g., during which a UE 120 is awake or in an active state) and an opportunity to enter a DRX sleep state 415. As used herein, a time during which the UE 120 is configured to be in an active state during the DRX on duration 410 may be referred to as an active time, and a time during which the UE 120 is configured to be in the DRX sleep state 415 may be referred to as an inactive time. As described below, the UE 120 may monitor a physical downlink control channel (PDCCH) during the active time, and may refrain from monitoring the PDCCH during the inactive time.

During the DRX on duration 410 (e.g., the active time), the UE 120 may monitor a downlink control channel (e.g., a PDCCH), as shown by reference number 420. For example, the UE 120 may monitor the PDCCH for downlink control information (DCI) pertaining to the UE 120. If the UE 120 does not detect and/or successfully decode any PDCCH communications intended for the UE 120 during the DRX on duration 410, then the UE 120 may enter the sleep state 415 (e.g., for the inactive time) at the end of the DRX on duration 410, as shown by reference number 425. In this way, the UE 120 may conserve battery power and reduce power consumption. As shown, the DRX cycle 405 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 430 (e.g., which may extend the active time). The UE 120 may start the DRX inactivity timer 430 at a time at which the PDCCH communication is received (e.g., in a transmission time interval (TTI) in which the PDCCH communication is received, such as a slot, a subframe, and/or the like). The UE 120 may remain in the active state until the DRX inactivity timer 430 expires, at which time the UE 120 may enter the sleep state 415 (e.g., for the inactive time), as shown by reference number 435. During the duration of the DRX inactivity timer 430, the UE 120 may continue to monitor for PDCCH communications, may obtain a downlink data communication (e.g., on a downlink data channel, such as a physical downlink shared channel (PDSCH)) scheduled by the PDCCH communication, may prepare and/or transmit an uplink communication (e.g., on a physical uplink shared channel (PUSCH)) scheduled by the PDCCH communication, and/or the like. The UE 120 may restart the DRX inactivity timer 430 after each detection of a PDCCH communication for the UE 120 for an initial transmission (e.g., but not for a retransmission). By operating in this manner, the UE 120 may conserve battery power and reduce power consumption by entering the sleep state 415.

When DRX is configured for SC-PTM, a UE may discontinuously monitor for a PDCCH scheduling an SC-MCCH and/or a PDCCH scheduling an SC-MTCH using a DRX operation. In this case, a DRX operation may be performed independently for each G-RNTI and SC-RNTI used for SC-PTM. For example, a DRX configuration (e.g., configured by radio resource control (RRC) signaling), including an on-duration timer, an inactivity timer, an SC-PTM scheduling cycle, an SC-PTM scheduling offset, and/or the like, may be separate for each G-RNTI and SC-RNTI.

As described above, DRX may be used to control a UE's PDCCH monitoring in order to conserve power, extend battery life, and/or the like. In some cases, further power conservation for DRX may be achieved using a PDCCH-based wakeup signal (which may also be referred to as a power saving signal). A wakeup signal may be configured to be received in a PDCCH before a DRX active time. The wakeup signal may indicate whether the UE is to monitor for a PDCCH during an active time of a DRX cycle. Accordingly, the UE may not perform a wakeup operation for the active time when a wakeup signal is not detected (e.g., the UE may only wake up when a wakeup signal is detected).

In current wireless systems, a PDCCH-based wakeup signal may only be supported for a UE in an RRC-connected mode and for a long DRX cycle. That is, current wireless systems may not support a PDCCH-based wakeup signal for a UE in an RRC-idle mode or an RRC-inactive mode. However, in SC-PTM, broadcast/multicast transmissions (e.g., emergency alerts) may need to be received by UEs in an idle or inactive mode.

Some techniques and apparatuses described herein provide wakeup signaling for DRX for broadcast/multicast communication. In some aspects, wakeup signal indications may be provided per-MBMS session (e.g., per broadcast/multicast service) and multiplexed on the same PDCCH communication. In this way, wakeup signals may be received and used by idle and inactive UEs, thereby enabling wakeup signals to be used for broadcast/multicast communication. Accordingly, the techniques and apparatuses described herein enable a UE participating in broadcast/multicast communication to conserve power, extend battery life, and/or the like.

As indicated above, FIG. 4 is provided as an example. Other examples may differ from what is described with respect to FIG. 4.

FIGS. 5A-5E are diagrams illustrating examples 500, 520, 540, 570, and 575 associated with broadcast/multicast wakeup signals and DRX, in accordance with various aspects of the present disclosure. As shown in FIG. 5A, example 500 includes a base station 110 and a UE 120. In some aspects, the UE 120 may be one of a plurality of UEs associated with a cell or a multicast group, and the base station 110 may communicate with the plurality of UEs in connection with broadcast/multicast transmissions. In some aspects, the base station may transmit MBMS sessions associated with respective MBMSs. For example, the base station may transmit a first MBMS session associated with a first MBMS (e.g., video streaming), a second MBMS session associated with a second MBMS (e.g., emergency alerts), and so forth.

As shown in FIG. 5A, and by reference number 505, the base station 110 may transmit, and the UE 120 may receive, configuration information. The configuration information may indicate one or more DRX configurations (e.g., for SC-PTM). In some aspects, a single DRX configuration may be used for a plurality of MBMS sessions. In some aspects, a plurality of DRX configurations may be used for a plurality of MBMS sessions (e.g., a first DRX configuration may be for a first MBMS session, a second DRX configuration may be for a second MBMS session, and so forth). A DRX configuration may identify a DRX on-duration timer, a DRX inactivity timer, a DRX scheduling cycle, a DRX scheduling offset, and/or the like, as described above.

In some aspects, the configuration information may indicate a wakeup signal configuration that is to be used with one or more DRX configurations. A wakeup signal configuration may identify a set of wakeup signal monitoring occasions (e.g., PDCCH monitoring occasions) that is to be used to detect a PDCCH carrying wakeup signal information (which may be referred to herein as a PDCCH-WUS). In some aspects, a PDCCH-WUS may be associated with a plurality (e.g., a group) of MBMS sessions (e.g., rather than associated with a group of UEs). In some aspects, if an MBMS session is not configured for wakeup signal indication (or is not assigned a session-specific field in DCI, as described below), the UE 120 may determine that an on-duration timer for a next DRX cycle is to be (e.g., is always to be) initiated for the MBMS session.

As shown by reference number 510, the base station 110 may transmit, and the UE 120 may receive, DCI. For example, the UE 120 may receive a PDCCH-WUS that includes the DCI in a set of wakeup signal monitoring occasions. In some aspects, the DCI (e.g., the PDCCH-WUS) may be scrambled by the same RNTI (e.g., a cyclic redundancy check (CRC) of the DCI may be scrambled by the same RNTI), such as a group RNTI, for a plurality of MBMS sessions associated with the PDCCH-WUS. That is, the RNTI may be shared by a group of MBMS sessions (e.g., a group of MBMS sessions associated with the PDCCH-WUS).

The DCI may include a session-specific field for each MBMS session, of the plurality of MBMS sessions, associated with the PDCCH-WUS. For example, as shown in FIG. 5A, a first session-specific field of the DCI may include information for a first MBMS session, a second session-specific field of the DCI may include information for a second MBMS session, and so forth (e.g., up to K MBMS sessions configured to monitor a PDCCH-WUS). In other words, respective wakeup signal indications, for each MBMS session, may be multiplexed on the same PDCCH-WUS. Accordingly, a session-specific field in the DCI is used to indicate PDCCH monitoring behavior for the associated MBMS session, and may also be used to provide an SC-MCCH change notification for all MBMS sessions, as described below.

In some aspects, a session-specific field may include a wakeup signal indication for the MBMS session associated with the session-specific field. In some aspects, the base station 110 may determine, for the MBMS session, whether the UE 120 is to perform a wakeup operation for a DRX cycle (e.g., the next DRX cycle). Accordingly, the wakeup signal indication in the session-specific field may include a value that is based at least in part on whether the UE 120 is to perform the wakeup operation for the DRX cycle. For example, the session-specific field may include a first value if the UE 120 is to perform the wakeup operation, a second value if the UE 120 is not to perform the wakeup operation, and/or the like. In some aspects, the base station 110 may determine, for the MBMS session, that the UE 120 is to perform the wakeup operation (e.g., is to initiate PDCCH monitoring for the next DRX cycle) based at least in part on a determination that the UE 120 is to receive a PDCCH that schedules an SC-MCCH or an SC-MTCH.

In some aspects, the base station 110 may transmit, and the UE 120 may receive, a PDCCH-WUS, carrying the DCI, in a set of wakeup signal monitoring occasions. In some aspects, a content of a session-specific field of the DCI may be based at least in part on an SC-PTM DRX configuration for the MBMS session associated with the session-specific field, as described in more detail below. As described above, a single DRX configuration may be used for all MBMS sessions associated with session-specific fields in the DCI. Alternatively, as described above, an independent DRX configuration may be used for each MBMS session associated with session-specific fields in the DCI.

In some aspects, the UE 120 may monitor a set of wakeup signal monitoring occasions outside of (e.g., not during) a DRX active time of a DRX cycle. In some aspects, if the UE 120 is to receive multiple MBMS sessions, then the UE 120 may monitor multiple sets of wakeup signal monitoring occasions (e.g., associated with the multiple MBMS sessions) outside of a DRX active time common to the multiple MBMS sessions.

As shown by reference number 515, the UE 120 may selectively perform, for an MBMS session, a wakeup operation for a DRX cycle based at least in part on a wakeup signal indicated for the MBMS session in the DCI. That is, the UE 120 may selectively perform, for an MBMS session, a wakeup operation for a DRX cycle based at least in part on a value of a session-specific field of the DCI associated with the MBMS session. For example, if the session-specific field indicates, for the MBMS session, that the UE 120 is to wake up for the next DRX cycle, then the UE 120 may perform the wakeup operation for the next DRX cycle. As another example, if the session-specific field indicates, for the MBMS session, that the UE 120 is not to wake up for one or more subsequent DRX cycles, then the UE 120 may not perform the wakeup operation for the one or more subsequent DRX cycles.

In some aspects, the UE 120 may perform, for an MBMS session, the wakeup operation for the next DRX cycle based at least in part on an indication (e.g., in a session-specific field of the DCI associated with the MBMS session) that the UE 120 is to wake up. In this case, the UE 120 may monitor PDCCH monitoring occasions during an active time of the DRX cycle, and may detect a PDCCH that schedules an SC-MCCH or an SC-MTCH.

FIG. 5B shows an example 520 of DRX operations performed according to a single DRX configuration used for a plurality of MBMS sessions (e.g., a plurality of MBMS sessions associated with a PDCCH-WUS). In this example, a single set of wakeup signal monitoring occasions 525 may be used for the plurality of MBMS sessions. That is, the UE 120 may monitor the set of wakeup signal monitoring occasions 525 for a PDCCH-WUS that carries DCI indicating wakeup signal indications for the plurality of MBMS sessions in respective session-specific fields of the DCI. As shown, the set of wakeup signal monitoring occasions 525 may be associated with each DRX cycle 530 configured by the single DRX configuration. In particular, the set of wakeup signal monitoring occasions 525 may be before each DRX cycle 530.

In the example 520, a wakeup signal may indicate whether the UE 120 is to initiate an on-duration timer (e.g., drx-onDurationTimer) for a subsequent DRX cycle 530, or whether the UE 120 is not to initiate an on-duration timer for one or more subsequent DRX cycles 530 (e.g., for N subsequent DRX cycles 530, where Nis indicated in a session-specific field of DCI). In this case, a session-specific field may be allocated two bits for wakeup signal indication. For example, a wakeup signal may indicate whether the UE 120 is to start PDCCH monitoring for the next DRX cycle 530 (e.g., using a value of “00” for the wakeup signal), whether the UE 120 is to skip PDCCH monitoring in the next DRX cycle 530 (e.g., using a value of “01” for the wakeup signal), whether the UE 120 is to skip PDCCH monitoring in the next two DRX cycles 530 (e.g., using a value of “10”) for the wakeup signal, and/or the like. In some aspects, if a wakeup signal indicates that PDCCH monitoring for an MBMS session is to be skipped for N (where N>1) DRX cycles 530, then the UE 120 may skip monitoring the set of wakeup signal monitoring occasions 525 for one or more DRX cycles 530, and resume monitoring the set of wakeup signal monitoring occasions 525 before the N−1 DRX cycle 530 (e.g., if the UE 120 receives only the MBMS session, and does not receive other MBMS sessions).

As shown in the example 520, before a DRX cycle 530-1, the UE 120 may monitor the set of wakeup signal monitoring occasions 525, and receive DCI in a PDCCH-WUS 535. The DCI may include a first wakeup signal indication in a first session-specific field for a first MBMS session 0, a second wakeup signal indication in a second session-specific field for a second MBMS session 1, and so forth (e.g., up to a total quantity of MBMS sessions associated with the PDCCH-WUS 535). In an example, the first wakeup signal indication of the DCI may indicate that the UE 120 is to wake up (e.g., for PDCCH monitoring) for the next DRX cycle 530-1 for the first MBMS session 0, and the second wakeup signal indication of the DCI may indicate that the UE 120 is not to wake up for the next two DRX cycles 530-1 and 525-2 for the second MBMS session 1. The UE 120 may continue to monitor the set of wakeup signal monitoring occasions 525 before each DRX cycle 530 for DCI that includes wakeup signal indications, as described above and as further shown in the example 520.

FIG. 5C shows an example 540 of DRX operations performed according to a plurality of DRX configurations used for a plurality of MBMS sessions (e.g., a plurality of MBMS sessions associated with a PDCCH-WUS). For example, a first MBMS session 0 may be associated with a first DRX configuration, and a second MBMS session 1 may be associated with a second DRX configuration. The first DRX configuration and the second DRX configuration may be different (e.g., may indicate different DRX cycles, different DRX active times, different DRX inactive times, and/or the like). Accordingly, respective sets of wakeup signal monitoring occasions 545-1, 540-2 may be used for the plurality of MBMS sessions (e.g., the first MBMS session 0 may be associated with the first set of wakeup signal monitoring occasions 545-1, and the second MBMS session 1 may be associated with the second set of wakeup signal monitoring occasions 545-2). In some aspects, the UE 120 may receive (e.g., may be required to receive) a PDCCH-WUS for an MBMS session in a set of wakeup signal monitoring occasions associated with the MBMS session.

As shown, the first set of wakeup signal monitoring occasions 545-1 may be associated with (e.g., may be before) each DRX cycle 550 configured by the first DRX configuration, and the second set of wakeup signal monitoring occasions 545-2 may be associated with (e.g., may be before) each DRX cycle 555 configured by the second DRX configuration. In some aspects, the sets of wakeup signal monitoring occasions 545-1, 540-2 may overlap in time (e.g., overlap within a pre-wakeup gap (e.g., ps_Offset) located prior to a slot in which a DRX on-duration timer is configured to start), may not overlap in time, or may overlap in time only with respect to particular DRX cycles.

In the example 540, a wakeup signal may indicate whether the UE 120 is to initiate an on-duration timer for a subsequent DRX cycle. In this case, a session-specific field may be allocated one bit for wakeup signal indication. For example, a wakeup signal may indicate whether the UE 120 is to start PDCCH monitoring for the next DRX cycle (e.g., using a value of “1” for the wakeup signal), whether the UE 120 is to skip PDCCH monitoring in the next DRX cycle (e.g., using a value of “0” for the wakeup signal), and/or the like.

As shown in the example 540, before a DRX cycle 550, the UE 120 may monitor the first set of wakeup signal monitoring occasions 545-1, and receive first DCI in a PDCCH-WUS 560. The first DCI may provide a wakeup signal indication for the first MBMS session 0 in a session-specific field of the first DCI associated with the first MBMS session 0. Before a DRX cycle 555, the UE 120 may monitor the second set of wakeup signal monitoring occasions 545-2, and receive second DCI in a PDCCH-WUS 565. The second DCI may provide a wakeup signal indication for the second MBMS session 1 in a session-specific field of the second DCI associated with the second MBMS session 1.

In an example, the wakeup signal indication of the first DCI may indicate that the UE 120 is to wake up (e.g., for PDCCH monitoring) for the next DRX cycle 550 for the first MBMS session 0, and the wakeup signal indication of the second DCI may indicate that the UE 120 is to wake up (e.g., for PDCCH monitoring) for the next DRX cycle 555 for the second MBMS session 1. The UE 120 may continue to monitor the first set of wakeup signal monitoring occasions 545-1 before each DRX cycle 550 for the first MBMS session, and monitor the second set of wakeup signal monitoring occasions 545-2 before each DRX cycle 555 for the second MBMS session, for DCI that includes wakeup signal indications, as described above and as further shown in the example 540.

FIG. 5D shows an example 570 of DRX operations performed according to a plurality of DRX configurations used for a plurality of MBMS sessions (e.g., a plurality of MBMS sessions associated with a PDCCH-WUS), as described above in connection with FIG. 5C. As shown in FIG. 5D, the first set of wakeup signal monitoring occasions 545-1 and the second set of wakeup signal monitoring occasions 545-2 may overlap in time. In this case, the UE 120 may receive DCI in multiple PDCCH-WUSs associated with different MBMS sessions.

For example, the UE 120 may receive DCI, in the first set of wakeup signal monitoring occasions 545-1 (e.g., associated with the first MBMS session 0), indicating wakeup signal indications for the first MBMS session 0 and/or the second MBMS session 1. Similarly, the UE 120 may receive DCI, in the second set of wakeup signal monitoring occasions 545-2 (e.g., associated with the second MBMS session 1), indicating wakeup signal indications for the first MBMS session 0 and/or the second MBMS session 1.

Accordingly, as shown in the example 570, the UE 120 may monitor the first set of wakeup signal monitoring occasions 545-1, and receive first DCI in an earlier PDCCH-WUS 560. The first DCI may include a first wakeup signal indication in a first session-specific field for the first MBMS session 0, and a second wakeup signal indication in a second session-specific field for the second MBMS session 1. As shown, the first wakeup signal may indicate that the UE 120 is to initiate an on-duration timer for the first MBMS session 0, and the second wakeup signal may indicate that the UE 120 is not to initiate an on-duration timer for the second MBMS session 1. As further shown in the example 570, the UE 120 may monitor the second set of wakeup signal monitoring occasions 545-2, and receive second DCI in a later PDCCH-WUS 565. As shown, the first wakeup signal in the second DCI may indicate that the UE 120 is to initiate an on-duration timer for the first MBMS session 0 (as also indicated by the first DCI), and the second wakeup signal in the second DCI may indicate that the UE 120 is to initiate an on-duration timer for the second MBMS session 1 (a different wakeup signal indication than the first DCI).

In other words, if a wakeup signal in an earlier DCI received in a first set of wakeup signal monitoring occasions does not indicate, for an MBMS session, that the UE 120 is to start PDCCH monitoring in the next DRX cycle, then a wakeup signal in a later DCI received in a second set of wakeup signal monitoring occasions may indicate, for the MBMS session, that the UE 120 is to start PDCCH monitoring in the next DRX cycle (e.g., when the set of wakeup signal monitoring occasions, in which the earlier DCI and the later DCI are received, overlap in time). Accordingly, the UE 120 may continuously monitor a set of wakeup signal monitoring occasions associated with an MBMS session until the UE 120 receives DCI (e.g., in the set of wakeup signal monitoring occasions or another set of wakeup signal monitoring occasions overlapping in time with the set of wakeup signal monitoring occasions) that indicates that the UE 120 is to initiate an on-duration timer for the next DRX cycle for the MBMS session (or until an end of the set wakeup signal monitoring occasions).

In other words, after receiving DCI in a first set of wakeup signal monitoring occasions associated with a first MBMS session, the UE 120 may continue to monitor a second set of wakeup signal monitoring occasions (e.g., that overlap in time with the first set) associated with a second MBMS session, unless the DCI indicates, for the second MBMS session, that an on-duration timer is to be initiated for the next DRX cycle. In some aspects, if a wakeup signal in an earlier DCI does indicate, for an MBMS session, that the UE 120 is to start PDCCH monitoring in the next DRX cycle, then a wakeup signal in a later DCI may indicate, for the MBMS session, that the UE 120 is not to start PDCCH monitoring in the next DRX cycle.

In some aspects, when a first set of wakeup signal monitoring occasions associated with a first MBMS session overlap in time with a second set of wakeup signal monitoring occasions associated with a second MBMS session, DCI may indicate whether the UE 120 is to continue monitoring the first set of wakeup signal monitoring occasions or the second set of wakeup signal monitoring occasions. For example, a session-specific field of the DCI, associated with an MBMS session, may include a value (e.g., a bit) to indicate whether the UE 120 is to continue to monitor a set of wakeup signal monitoring occasions, associated with the MBMS session, after the DCI is received (e.g., whether the UE 120 is to continue monitoring or terminate monitoring before the end of the set of wakeup signal monitoring occasions). As an example, after receiving DCI in a first set of wakeup signal monitoring occasions associated with a first MBMS session, the UE 120 may continue to monitor a second set of wakeup signal monitoring occasions (e.g., that overlap in time with the first set) associated with a second MBMS session, unless the DCI indicates, for the second MBMS session, that the UE 120 is to terminate monitoring the second set of wakeup signal monitoring occasions.

FIG. 5E shows an example 575 of MCCH change notification. As described above, in some aspects, a PDCCH-WUS may provide an SC-MCCH change notification. For example, a field of DCI may indicate an SC-MCCH change notification for all MBMS sessions. In some aspects, the field may include two bits (e.g., a two-bit bitmap) for change notification. A first bit may indicate whether there is a change to an MBMS, and a second bit may indicate whether a new MBMS, transmitted using SC-PTM, is to start.

As shown in the example 575, the UE 120 may monitor a set of wakeup signal monitoring occasions, and receive a PDCCH-WUS 580 that indicates a change notification for all MBMS sessions (e.g., according to the two-bit SC-MCCH change notification in the DCI). Based at least in part on receiving the change notification, the UE 120 may perform a wakeup operation for the next SC-MCCH modification period 585. Accordingly, the UE 120 may perform PDCCH monitoring in the next SC-MCCH modification period 585, and receive a PDCCH 590 that schedules an SC-MCCH. Accordingly, the UE 120 may receive the SC-MCCH in a PDSCH 595 (e.g., in the SC-MCCH modification period) according to the scheduling. The SC-MCCH may indicate one or more changes to the SC-PTM configuration information.

As indicated above, FIGS. 5A-5E are provided as examples. Other examples may differ from what is described with respect to FIGS. 5A-5E.

FIG. 6 is a diagram illustrating an example process 600 performed, for example, by a UE, in accordance with various aspects of the present disclosure. Example process 600 is an example where the UE (e.g., UE 120 and/or the like) performs operations associated with broadcast/multicast wakeup signals and DRX.

As shown in FIG. 6, in some aspects, process 600 may include receiving, from a base station, downlink control information that indicates a wakeup signal for a broadcast/multicast session in a session-specific field of the downlink control information (block 610). For example, the UE (e.g., using antenna 252, DEMOD 254, MIMO detector 256, receive processor 258, controller/processor 280, and/or the like) may receive, from a base station, downlink control information that indicates a wakeup signal for a broadcast/multicast session in a session-specific field of the downlink control information, as described above. In some aspects, process 600 may include determining the wakeup signal that is indicated in the session-specific field (e.g., determining a content of the session-specific field) of the downlink control information based at least in part on a DRX configuration (e.g., an SC-PTM DRX configuration) associated with the broadcast/multicast session.

As further shown in FIG. 6, in some aspects, process 600 may include selectively performing, for the broadcast/multicast session, a wakeup operation for a discontinuous reception cycle based at least in part on the wakeup signal (block 620). For example, the UE (e.g., using antenna 252, DEMOD 254, MIMO detector 256, receive processor 258, controller/processor 280, and/or the like) may selectively perform, for the broadcast/multicast session, a wakeup operation for a discontinuous reception cycle based at least in part on the wakeup signal, as described above. In some aspects, process 600 may include monitoring a PDCCH for an MCCH at a start of a next SC-MCCH modification period (e.g., after receiving the downlink control information), based at least in part on the wakeup signal (e.g., based at least in part on selectively performing the wakeup operation).

Process 600 may include additional aspects, such as any single aspect or any combination of aspects described below and/or in connection with one or more other processes described elsewhere herein.

With respect to process 600, in a first aspect, the downlink control information indicates wakeup signals for a plurality of broadcast/multicast sessions in respective session-specific fields of the downlink control information.

With respect to process 600, in a second aspect, alone or in combination with the first aspect, the downlink control information is scrambled by a group radio network temporary identifier associated with the plurality of broadcast/multicast sessions.

With respect to process 600, in a third aspect, alone or in combination with one or more of the first and second aspects, the broadcast/multicast session is one of a plurality of broadcast/multicast sessions associated with a single discontinuous reception configuration.

With respect to process 600, in a fourth aspect, alone or in combination with one or more of the first through third aspects, process 600 includes monitoring a set of wakeup signal monitoring occasions associated with the plurality of broadcast/multicast sessions.

With respect to process 600, in a fifth aspect, alone or in combination with one or more of the first through fourth aspects, the wakeup signal in the session-specific field indicates, for the broadcast/multicast session, whether an on-duration timer is to be initiated for a subsequent discontinuous reception cycle, or whether the on-duration timer is not to be initiated for one or more subsequent discontinuous reception cycles.

With respect to process 600, in a sixth aspect, alone or in combination with one or more of the first through fifth aspects, the broadcast/multicast session is one of a plurality of broadcast/multicast sessions associated with a plurality of discontinuous reception configurations.

With respect to process 600, in a seventh aspect, alone or in combination with one or more of the first through sixth aspects, process 600 includes monitoring respective sets of wakeup signal monitoring occasions associated with each of the plurality of broadcast/multicast sessions.

With respect to process 600, in an eighth aspect, alone or in combination with one or more of the first through seventh aspects, the wakeup signal in the session-specific field indicates, for the broadcast/multicast session, whether an on-duration timer is to be initiated for a subsequent discontinuous reception cycle.

With respect to process 600, in a ninth aspect, alone or in combination with one or more of the first through eighth aspects, a first set of wakeup signal monitoring occasions associated with the broadcast/multicast session, and a second set of wakeup signal monitoring occasions associated with another broadcast/multicast session of the plurality of broadcast/multicast sessions, overlap in time, and the downlink control information is received in the first set of wakeup signal monitoring occasions or the second set of wakeup signal monitoring occasions.

With respect to process 600, in a tenth aspect, alone or in combination with one or more of the first through ninth aspects, process 600 includes monitoring the first set of wakeup signal monitoring occasions, after receiving the downlink control information in the second set of wakeup signal monitoring occasions, unless the downlink control information indicates that an on-duration timer is to be initiated for the broadcast/multicast session.

With respect to process 600, in an eleventh aspect, alone or in combination with one or more of the first through tenth aspects, the downlink control information indicates whether the UE is to continue monitoring the first set of wakeup signal monitoring occasions or the second set of wakeup signal monitoring occasions after receiving the downlink control information.

With respect to process 600, in a twelfth aspect, alone or in combination with one or more of the first through eleventh aspects, process 600 includes monitoring one or more sets of wakeup signal monitoring occasions outside of a discontinuous reception active time that is common to the broadcast/multicast session and another broadcast/multicast session.

With respect to process 600, in a thirteenth aspect, alone or in combination with one or more of the first through twelfth aspects, process 600 includes determining that an on-duration timer is to be initiated for the discontinuous reception cycle based at least in part on a determination that a wakeup signal indication is not configured for the broadcast/multicast session.

With respect to process 600, in a fourteenth aspect, alone or in combination with one or more of the first through thirteenth aspects, the downlink control information provides a change notification for a multicast control channel.

With respect to process 600, in a fifteenth aspect, alone or in combination with one or more of the first through fourteenth aspects, process 600 includes monitoring a PDCCH for the multicast control channel at a start of a next modification period, based at least in part on the change notification.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with various aspects of the present disclosure. Example process 700 is an example where the base station (e.g., base station 110 and/or the like) performs operations associated with broadcast/multicast wakeup signals and DRX.

As shown in FIG. 7, in some aspects, process 700 may include determining, for a broadcast/multicast session, whether a UE is to perform a wakeup operation for a discontinuous reception cycle (block 710). For example, the base station (e.g., using transmit processor 220, receive processor 238, controller/processor 240, memory 242, and/or the like) may determine, for a broadcast/multicast session, whether a UE is to perform a wakeup operation for a discontinuous reception cycle, as described above.

As further shown in FIG. 7, in some aspects, process 700 may include transmitting, to the UE, downlink control information that indicates a wakeup signal for the broadcast/multicast session in a session-specific field of the downlink control information (block 720). For example, the base station (e.g., using controller/processor 240, transmit processor 220, TX MIMO processor 230, MOD 232, antenna 234, and/or the like) may transmit, to the UE, downlink control information that indicates a wakeup signal for the broadcast/multicast session in a session-specific field of the downlink control information, as described above.

Process 700 may include additional aspects, such as any single aspect or any combination of aspects described below and/or in connection with one or more other processes described elsewhere herein.

With respect to process 700, in a first aspect, the downlink control information indicates wakeup signals for a plurality of broadcast/multicast sessions in respective session-specific fields of the downlink control information.

With respect to process 700, in a second aspect, alone or in combination with the first aspect, the downlink control information is scrambled by a group radio network temporary identifier associated with the plurality of broadcast/multicast sessions.

With respect to process 700, in a third aspect, alone or in combination with one or more of the first and second aspects, the broadcast/multicast session is one of a plurality of broadcast/multicast sessions associated with a single discontinuous reception configuration.

With respect to process 700, in a fourth aspect, alone or in combination with one or more of the first through third aspects, a set of wakeup signal monitoring occasions is associated with the plurality of broadcast/multicast sessions.

With respect to process 700, in a fifth aspect, alone or in combination with one or more of the first through fourth aspects, the wakeup signal in the session-specific field indicates, for the broadcast/multicast session, whether an on-duration timer is to be initiated for a subsequent discontinuous reception cycle, or whether the on-duration timer is not to be initiated for one or more subsequent discontinuous reception cycles.

With respect to process 700, in a sixth aspect, alone or in combination with one or more of the first through fifth aspects, the broadcast/multicast session is one of a plurality of broadcast/multicast sessions associated with a plurality of discontinuous reception configurations.

With respect to process 700, in a seventh aspect, alone or in combination with one or more of the first through sixth aspects, respective sets of wakeup signal monitoring occasions are associated with each of the plurality of broadcast/multicast sessions.

With respect to process 700, in an eighth aspect, alone or in combination with one or more of the first through seventh aspects, the wakeup signal in the session-specific field indicates, for the broadcast/multicast session, whether an on-duration timer is to be initiated for a subsequent discontinuous reception cycle.

With respect to process 700, in a ninth aspect, alone or in combination with one or more of the first through eighth aspects, a first set of wakeup signal monitoring occasions associated with the broadcast/multicast session, and a second set of wakeup signal monitoring occasions associated with another broadcast/multicast session of the plurality of broadcast/multicast sessions, overlap in time, and the downlink control information is transmitted in the first set of wakeup signal monitoring occasions or the second set of wakeup signal monitoring occasions.

With respect to process 700, in a tenth aspect, alone or in combination with one or more of the first through ninth aspects, the downlink control information, transmitted in the second set of wakeup signal monitoring occasions, indicating that an on-duration timer is not to be initiated for the broadcast/multicast session indicates that the UE is to continue monitoring the first set of wakeup signal monitoring occasions after receiving the downlink control information.

With respect to process 700, in an eleventh aspect, alone or in combination with one or more of the first through tenth aspects, the downlink control information indicates whether the UE is to continue monitoring the first set of wakeup signal monitoring occasions or the second set of wakeup signal monitoring occasions after receiving the downlink control information.

With respect to process 700, in a twelfth aspect, alone or in combination with one or more of the first through eleventh aspects, the downlink control information is transmitted in one or more sets of wakeup signal monitoring occasions outside of a discontinuous reception active time that is common to the broadcast/multicast session and another broadcast/multicast session.

With respect to process 700, in a thirteenth aspect, alone or in combination with one or more of the first through twelfth aspects, an on-duration timer is to be initiated for the discontinuous reception cycle when a wakeup signal indication is not configured for the broadcast/multicast session.

With respect to process 700, in a fourteenth aspect, alone or in combination with one or more of the first through thirteenth aspects, the downlink control information provides a change notification for a multicast control channel.

With respect to process 700, in a fifteenth aspect, alone or in combination with one or more of the first through fourteenth aspects, the change notification indicates that the user equipment is to monitor a physical downlink control channel for the multicast control channel at a start of a next modification period.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment for wireless communication, comprising:
a memory; and
one or more processors coupled to the memory, the memory and the one or more processors configured to:
receive, from a base station, downlink control information that indicates a wakeup signal for a broadcast or multicast (broadcast/multicast) session in a session-specific field of the downlink control information; and
selectively perform, for the broadcast/multicast session, a wakeup operation for a discontinuous reception cycle based at least in part on the wakeup signal.

2. The user equipment of claim 1, wherein the downlink control information indicates wakeup signals for a plurality of broadcast/multicast sessions in respective session-specific fields of the downlink control information.

3. The user equipment of claim 2, wherein the downlink control information is scrambled by a group radio network temporary identifier associated with the plurality of broadcast/multicast sessions.

4. The user equipment of claim 1, wherein the broadcast/multicast session is one of a plurality of broadcast/multicast sessions associated with a single discontinuous reception configuration.

5. The user equipment of claim 4, wherein the memory and the one or more processors are further configured to:
monitor a set of wakeup signal monitoring occasions associated with the plurality of broadcast/multicast sessions.

6. The user equipment of claim 4, wherein the wakeup signal in the session-specific field indicates, for the broadcast/multicast session, whether an on-duration timer is to be initiated for a subsequent discontinuous reception cycle, or whether the on-duration timer is not to be initiated for one or more subsequent discontinuous reception cycles.

7. The user equipment of claim 1, wherein the broadcast/multicast session is one of a plurality of broadcast/multicast sessions associated with a plurality of discontinuous reception configurations.

8. The user equipment of claim 7, wherein the memory and the one or more processors are further configured to:
monitor respective sets of wakeup signal monitoring occasions associated with each of the plurality of broadcast/multicast sessions.

9. The user equipment of claim 7, wherein the wakeup signal in the session-specific field indicates, for the broadcast/multicast session, whether an on-duration timer is to be initiated for a subsequent discontinuous reception cycle.

10. The user equipment of claim 7, wherein a first set of wakeup signal monitoring occasions associated with the broadcast/multicast session, and a second set of wakeup signal monitoring occasions associated with another broadcast/multicast session of the plurality of broadcast/multicast sessions, overlap in time, and
wherein the downlink control information is received in the first set of wakeup signal monitoring occasions or the second set of wakeup signal monitoring occasions.

11. The user equipment of claim 10, wherein the memory and the one or more processors are further configured to:
monitor the first set of wakeup signal monitoring occasions, after receiving the downlink control information in the second set of wakeup signal monitoring occasions, unless the downlink control information indicates that an on-duration timer is to be initiated for the broadcast/multicast session.

12. The user equipment of claim 10, wherein the downlink control information indicates whether the user equipment is to continue monitoring the first set of wakeup signal monitoring occasions or the second set of wakeup signal monitoring occasions after receiving the downlink control information.

13. The user equipment of claim 1, wherein the memory and the one or more processors are further configured to:
monitor one or more sets of wakeup signal monitoring occasions outside of a discontinuous reception active time that is common to the broadcast/multicast session and another broadcast/multicast session.

14. The user equipment of claim 1, wherein the memory and the one or more processors are further configured to:
determine that an on-duration timer is to be initiated for the discontinuous reception cycle based at least in part on a determination that a wakeup signal indication is not configured for the broadcast/multicast session.

15. The user equipment of claim 1, wherein the downlink control information provides a change notification for a multicast control channel.

16. The user equipment of claim 15, wherein the memory and the one or more processors are further configured to:
monitor a physical downlink control channel for the multicast control channel at a start of a next modification period, based at least in part on the change notification.

17. A base station for wireless communication, comprising:
a memory; and
one or more processors coupled to the memory, the memory and the one or more processors configured to:
determine, for a broadcast or multicast (broadcast/multicast) session, whether a user equipment is to perform a wakeup operation for a discontinuous reception cycle; and
transmit, to the user equipment, downlink control information that indicates a wakeup signal for the broadcast/multicast session in a session-specific field of the downlink control information.

18. The base station of claim 17, wherein the downlink control information indicates wakeup signals for a plurality of broadcast/multicast sessions in respective session-specific fields of the downlink control information.

19. The base station of claim 18, wherein the downlink control information is scrambled by a group radio network temporary identifier associated with the plurality of broadcast/multicast sessions.

20. The base station of claim 17, wherein the broadcast/multicast session is one of a plurality of broadcast/multicast sessions associated with a single discontinuous reception configuration.

21. The base station of claim 20, wherein a set of wakeup signal monitoring occasions is associated with the plurality of broadcast/multicast sessions.

22. The base station of claim 20, wherein the wakeup signal in the session-specific field indicates, for the broadcast/multicast session, whether an on-duration timer is to be initiated for a subsequent discontinuous reception cycle, or whether the on-duration timer is not to be initiated for one or more subsequent discontinuous reception cycles.

23. The base station of claim 17, wherein the broadcast/multicast session is one of a plurality of broadcast/multicast sessions associated with a plurality of discontinuous reception configurations.

24. The base station of claim 23, wherein respective sets of wakeup signal monitoring occasions are associated with each of the plurality of broadcast/multicast sessions.

25. The base station of claim 23, wherein the wakeup signal in the session-specific field indicates, for the broadcast/multicast session, whether an on-duration timer is to be initiated for a subsequent discontinuous reception cycle.

26. The base station of claim 23, wherein a first set of wakeup signal monitoring occasions associated with the broadcast/multicast session, and a second set of wakeup signal monitoring occasions associated with another broadcast/multicast session of the plurality of broadcast/multicast sessions, overlap in time, and
wherein the downlink control information is transmitted in the first set of wakeup signal monitoring occasions or the second set of wakeup signal monitoring occasions.

27. The base station of claim 26, wherein the downlink control information, transmitted in the second set of wakeup signal monitoring occasions, indicating that an on-duration timer is not to be initiated for the broadcast/multicast session indicates that the user equipment is to continue monitoring the first set of wakeup signal monitoring occasions after receiving the downlink control information.

28. The base station of claim 26, wherein the downlink control information indicates whether the user equipment is to continue monitoring the first set of wakeup signal monitoring occasions or the second set of wakeup signal monitoring occasions after receiving the downlink control information.

29. The base station of claim 17, wherein the downlink control information is transmitted in one or more sets of wakeup signal monitoring occasions outside of a discontinuous reception active time that is common to the broadcast/multicast session and another broadcast/multicast session.

30. The base station of claim 17, wherein an on-duration timer is to be initiated for the discontinuous reception cycle when a wakeup signal indication is not configured for the broadcast/multicast session.

31. The base station of claim 17, wherein the downlink control information provides a change notification for a multicast control channel.

32. The base station of claim 31, wherein the change notification indicates that the user equipment is to monitor a physical downlink control channel for the multicast control channel at a start of a next modification period.

33. A non-transitory computer-readable medium storing a set of instructions for wireless communication, the set of instructions comprising:
one or more instructions that, when executed by one or more processors of a user equipment, cause the user equipment to:
receive, from a base station, downlink control information that indicates a wakeup signal for a broadcast or multicast (broadcast/multicast) session in a session-specific field of the downlink control information; and
selectively perform, for the broadcast/multicast session, a wakeup operation for a discontinuous reception cycle based at least in part on the wakeup signal.

34. A method of wireless communication performed by a user equipment, comprising:
receiving, from a base station, downlink control information that indicates a wakeup signal for a broadcast or multicast (broadcast/multicast) session in a session-specific field of the downlink control information; and
selectively performing, for the broadcast/multicast session, a wakeup operation for a discontinuous reception cycle based at least in part on the wakeup signal.

35. A method of wireless communication performed by a base station, comprising:
determining, for a broadcast or multicast (broadcast/multicast) session, whether a user equipment is to perform a wakeup operation for a discontinuous reception cycle; and
transmitting, to the user equipment, downlink control information that indicates a wakeup signal for the broadcast/multicast session in a session-specific field of the downlink control information.
